(19) United States
(12) Patent Application Publication
(10) Pub. No.: US 2007/0259306 A1
(43) Pub. Date: Nov. 8, 2007

(54) Orthodontic Plate and Method

(75) Inventors: Aaron T. Raines JR., Dallas, TX (US); Brandon G. Beckendorf, Dallas, TX (US)

Correspondence Address: BAKER BOTTS L.L.P., 2001 ROSS AVENUE, SUITE 600, DALLAS, TX, 75201-2980, US

(73) Assignee: OSTEOMED L.P.

(21) Appl. No.: 11/381,961

(22) Filed: May 5, 2006

(51) Int. Cl. A61C 3/00

(52) U.S. Cl. 433/18

(57) ABSTRACT

An orthodontic plate for use as a temporary bone anchor in conjunction with orthodontic treatment. The orthodontic plate includes a base and a stem extending from the base. A plurality of branches extend from the stem. In accordance with a particular embodiment of the present invention, each of the branches are configured to form respective open ended recesses.

### TECHNICAL FIELD OF THE INVENTION

The present disclosure relates generally to the field of orthodontic devices and, more particularly, to an orthodontic plate and method.

### BACKGROUND OF THE INVENTION

In traditional tooth movement, an orthodontist places orthodontic brackets on the teeth, and connects them to one another using orthodontic archwire. The archwire, in conjunction with tension bands, guides and provides tooth-moving forces to certain teeth, using other teeth as anchors. This traditional method of tooth movement however, has several potential shortcomings. For example, in some patients, the potential anchor tooth or teeth may be missing. Furthermore, a particular tooth serving as an anchor may actually move because of counter-forces caused by the tendency of the other teeth to resist movement.

Therefore, it is often desirable to move some teeth while stabilizing other teeth. Traditionally, this stabilization, or differential tooth movement, involves applying forces of smaller magnitude, or using a number of teeth as an anchor. However, when smaller forces are used, the length of time involved in the orthodontic treatment increases significantly. When multiple teeth serve as an anchor, the resulting tooth-movement may be somewhat unpredictable.

As with all forces in general, orthodontic forces adhere to Newton's “Law of Reciprocal Forces.” When orthodontics exert a force to retract or pull back a tooth, an “equal and opposite” force will tend to move another tooth or object forward. Depending on the ability of the anchor to resist this force, the anchor may move significantly, minimally, or not at all. The ability of a tooth to resist this force is known as anchorage. Orthodontists may offset these reciprocal tendencies by using an extra-oral force known as a headgear to boost the anchorage of the teeth and as a way of obtaining differential tooth movement. However, patients typically dislike the headgear and patient compliance is often inadequate. This compromises the orthodontic treatment as well as the result. Even when patients do wear headgear, the use is typically limited to about 10-12 hours per day. However, orthodontic forces are continuous. Therefore, even in “good” circumstances, the anchorage is typically fortified only 40-50% of the time.

Endosseous implants may be useful when space permits. For example, when a molar is missing, an endosseous implant may fit within a resulting gap. However, orthodontic treatment is often used to remedy overcrowding in full dentition where space is very limited. Additionally, endosseous implants are unsuitable in juveniles or adolescents, as a hole must be drilled into the alveolar portion of the jawbone. Insertion of an endosseous implant into this area will harm unerupted teeth that are still forming. Further, since young patients are still growing, an endosseous implant will become engulfed as vertical development of the alveolar bone continues, and the implant will progressively “sink,” becoming inaccessible and difficult to remove.

Subperiosteal bone anchors can be attached to bone just about anywhere in the mouth with little, if any likelihood of destruction of bone or teeth. U.S. Pat. Nos. 5,066,224 and 5,538,427 disclose an orthodontic anchorage system that does not penetrate the bone as endosseous implants. Instead, subperiosteal anchors merely rest on the surface of the bone.

These types of anchors are rigid, thick and do not easily conform to the unique bone morphology found at the surgical site or into a desired direction. This limits intraoral placement to locations where overlying soft tissue is relatively thick, such as in the palate. Further, the bone-anchor interface surface may be very complex to allow and foster bone ingrowth. Additionally the attachment procedure connecting the device to teeth is complex and often requires additional laboratory steps. Furthermore, a subsequent surgical procedure is necessary to uncover a portion of the anchor and attach an extruding abutment. This procedure is performed after a period of healing and osseointegration.

Recently, small bone plates in numerous configurations have come into use in orthognathic and maxillofacial reconstructive surgery with such plates. These plates may be deformed and contoured to fit to a variety of irregular bony surgical sites. These plates are available in “Y,” “T,” “L,” “I,” and a number of more complex shape configurations. Additionally, the plates have variable thicknesses and degrees of malleability.

U.S. Pat. No. 5,853,291 discloses a thin bone anchor for use in conjunction with orthodontic appliances. The bone anchor has a plurality of moldable, scalloped leaves and arms to facilitate bone overgrowth and an upwardly extending stem with a variety of attachment connection mechanisms. The entire base and leaves of the anchor are scalloped to foster osteointegration. A sphere or rectangular tube projects upward. This anchor, although small, thin and moldable to bone, is highly three dimensional with its orthodontic attachment rising up from a planar fixation against the bone. This anchor is also structured with tapering, leaf-like projections to foster osteointegration.

The plates readily usable in orthognathic and maxillofacial surgery, as described above, are generally relatively small (about 20-40 mm. in their major dimension). These small, malleable bone plates contain a plurality of holes through which standard bone screws and fasteners can pass to attach the plate to bone and through which archwire can be threaded. Although the plates function as adequate anchors and do not osteointegrate, holes are the only means of attaching the plate to other orthodontics. Since “closed” or “ring-type” orthodontic connectors, such as elastic bands and chains, cannot be readily attached to the closed holes, these plates provide limited directional torque and control. This restricts treatment options, compromises outcome, and often prolongs treatment time. These prior art bone plates are currently manufactured and readily obtainable from companies such as KLS Martin L. P. of Jacksonville, Fla., Walter Lorenz Surgical Instruments, Inc. of Jacksonville, Fla., and Stryker Corp. of Kalamazoo, Mich.

U.S. Pat. No. 6,827,574 discloses a plate having a non-osteointegrating, bendable temporary bone anchor and tension band connector for resisting tension band forces of the tension band attached to a tooth to be moved that includes enhanced directional tension band torque and control. This plate may be installed and removed with minimal surgical trauma, morbidity and healing time. However, this plate requires an attached orthodontic appliance, such as a wire guide or tension band bracket. Depending on the application, the attachment of the orthodontic appliance to the plate may require additional procedures. Additionally, the orthodontic appliance is not as thin as the plate itself, which can cause irritation of the soft tissues.

### SUMMARY OF THE INVENTION

The present invention relates generally to an orthodontic device. More specifically, the present invention relates to an orthodontic plate for use as a temporary bone anchor in conjunction with orthodontic treatment.

In one embodiment of the present invention, the orthodontic plate includes a base and a stem extending from the base. A plurality of branches extend from the stem. In accordance with a particular embodiment of the present invention, each of the branches may be configured to form a respective open ended recess.

In another embodiment of the present invention the orthodontic plate is formed from a single sheet of material and has a base, which is connectable to bone, a stem coupled to the base, and a plurality of branches coupled to the stem. Any of the plurality of branches is connectable to at least one orthodontic bracket via an orthodontic connector.

In yet another embodiment of the present invention the orthodontic plate is formed from a single sheet of material and has a base, which is connectable to bone, a stem, and a plurality of branches extending from the stem. The base, the stem, and the plurality of branches all lie substantially within a single plane. Any of the plurality of branches is connectable to at least one orthodontic bracket via a closed orthodontic connector. Additionally, the plurality of branches is configured such that the orthodontic plate can support a load in any direction lying substantially within the plane.

### BRIEF DESCRIPTION OF THE DRAWINGS

FIG. 1A is a front elevational view of one embodiment of an orthodontic plate in accordance with the present invention.

FIG. 1B is a front elevational view of another embodiment of an orthodontic plate in accordance with the present invention.

FIG. 2A is another front elevational view of the embodiment illustrated in FIG. 1A.

FIG. 2B is a rear elevational view of the embodiment illustrated in FIGS. 1A and 2A.

FIG. 3A-3E are front elevational views of five representatives of prior art bone plates.

FIG. 4 is a side elevation view of one embodiment of the present invention attached to bone and in use.

FIG. 5 is a perspective view of one embodiment of the present invention installed and bent into conforming position in use where a tooth is missing.

FIG. 6 is a side elevation view of another embodiment of the present invention using a chain connected to a tooth over a space created by a number of missing teeth.

FIG. 7 is a side elevation view of one embodiment of the present invention in use.

FIG. 8 is a front elevation view of another embodiment of the present invention.

### DETAILED DESCRIPTION OF THE INVENTION

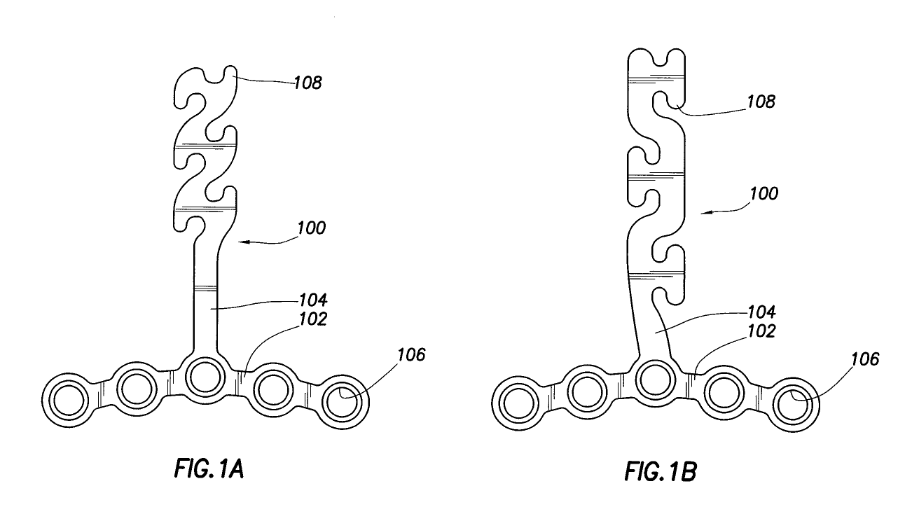

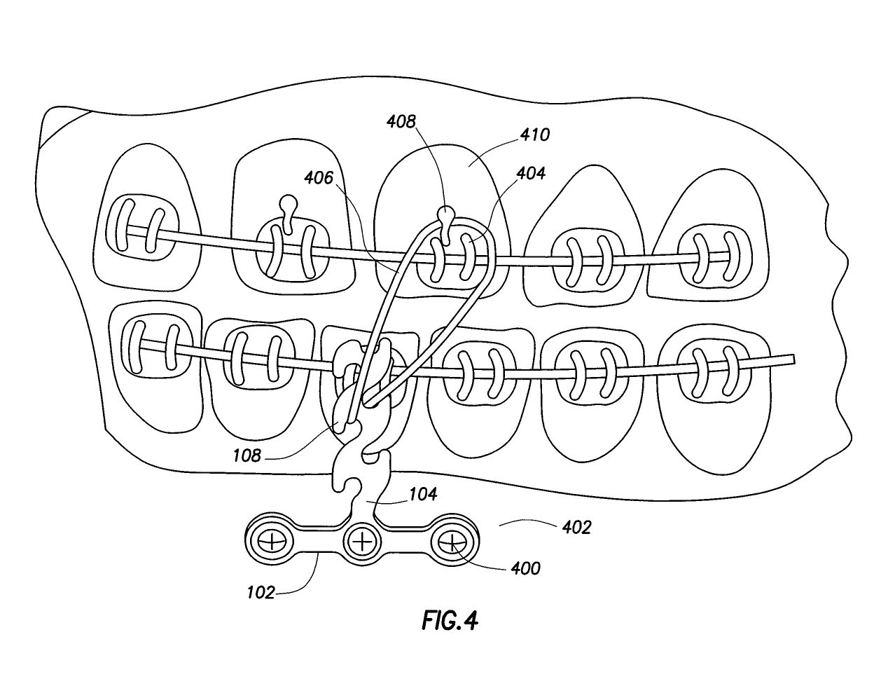

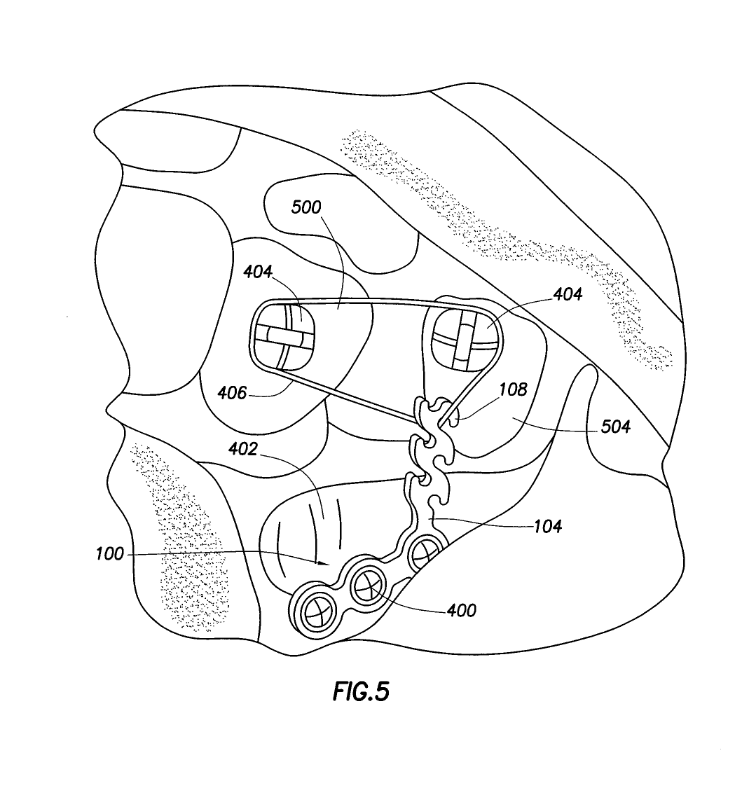

Referring now to the drawings, and in particular to FIGS. 1A and 1B, orthodontic plate 100 is shown having a bendable, malleable, substantially thin, planar construction shown in the form of a T-shaped body. Orthodontic plate 100 has a base 102, and a stem 104, which, upon installation, protrudes through the soft tissue of the gum substantially adjacent a lateral side of the dentition (shown in FIG. 5). The base 102 unitarily formed at one end of the stem 104 includes one or more holes 106 (e.g., 0.160″ diameter) extending through the base 102. The holes 106 are adapted to receive one or more fasteners 400 (shown in FIG. 4), such as flush-mounting screws. The base 102 and the stem 104 are planar, yet bendable to conform to bone contour and directionally fit a desired space. The length of the stem may vary for different applications, but may fall within the range of approximately 0.250″ to 0.450″.

The fasteners 400 situated within the holes 106 anchor the base 102 against the bone, either mandible or maxilla, such that the base 102 lies firmly flush, desirably in conforming engagement with the bone, in the selected location under the periosteum and other soft tissues. The stem 104 extends from the base 102 through the soft tissues substantially beside the tooth without interfering with the occlusal surface of the tooth. The orthodontist positions the stem 104 at a level and angle sufficient to provide the desired directional movement and anchorage. A plurality of branches, hooks, or projections 108 are unitarily formed at the end of the stem 104 extending out of the soft tissues.

The branches 108 may lie within the same plane as the base 102 and the stem 104. However, the branches 108 may be bent out of this plane, and may even be perpendicular to the base 102 and the stem 104 (e.g., into the page or out of the page of FIG. 1A). The branches 108 are desirably configured to receive any type of orthodontic connector, such as rubber bands, chains, orthodontic wire, and the like. The overall height of the orthodontic plate may be widely varied depending upon the specific application. The height may fall within the range of approximately 0.80″ to 1.10″ for some applications.

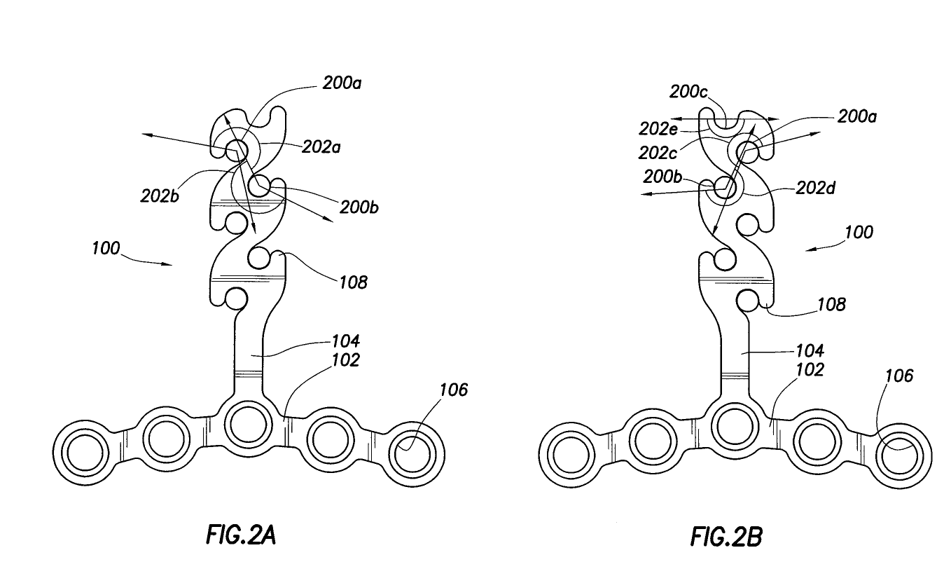

As shown by FIGS. 1A and 1B, the shape and configuration of the branches 108 may vary, depending on the specific application. The branches 108 may extend in any number of directions from the stem 104, such as upwardly, downwardly, outwardly, inwardly, or any other direction suited to a particular application. It may also be desirable for some applications, that the branches 108 extend in at least two different directions. Each branch 108 is configured to form at least one open ended recess 200 (as opposed to a closed ended loop or circular opening) that is suitable to receive and support an orthodontic connector. As shown in FIGS. 2A and 2B, this provides unions having recesses 200 that face different directions. Each recess 200 corresponds to a range 202 of directions in which the orthodontic plate 100 can adequately support a load. Therefore, providing recesses 200 having multiple orientations allows for load support in more directions.

For example, FIG. 2A shows a first range 202a of load capacity. Any orthodontic connector, such as a band, chain, etc. placed within a first recess 200a can support a load in any direction falling within the first range 202a. Likewise, any orthodontic connector placed within a second recess 200b can support a load in any direction falling within a second range 202b. In accordance with a particular embodiment of the present invention, first range 202a and second range 202b may each be approximately equal to 257° as approximately illustrated in FIG. 2A. The “overlap” of 202a and 202b may be approximately 77°.

Similarly, as shown in FIG. 2B, the oral surgeon can turn over the orthodontic plate 100 to obtain load bearing capacity in additional directions. In this instance, the first recess 200a and the second recess 200b provide load bearing capacity in a third range 202c and a fourth range 202d respectively. Because of the overlap in the directions of the ranges 202, the orthodontic plate 100 can support a load in any direction, so long as the oral surgeon chooses a proper orientation of the orthodontic plate 100, and applies the load to a proper recess 200 or branch 108. Additionally, the oral surgeon may utilize the same orthodontic plate 100 for several treatment approaches.

In FIG. 2A, recesses that are configured to support a load capacity from any direction within first range 202a are on the left hand side of FIG. 2A, and recesses that are configured to support a load capacity from any direction within second range 202b are on the right side of FIG. 2A. This configuration allows for a more compact (e.g., shorter) overall height of orthodontic plate, when compared to the configuration of FIG. 1B (recesses configured to support load capacities from different directions are on the same side of the orthodontic plate).

As illustrated in FIG. 2B, an end of the stem 104 opposite the base 102 includes a top recess 200c. An orthodontic connector placed within recess 200c can support a load in any direction falling within the range 202e. In accordance with a particular embodiment of the present invention, range 202e may be approximately 180°. However, range 202e may be greater than, or less than 180°, depending upon the specific configuration of the orthodontic plate, and recess 200c.

It is worth noting that the orthodontic plate 100, including the base 102, the stem 104, and the branches 108 is small and thin, which allows any portion of the orhtodontic plate to be conotoured, bent and/or cut, in order to conform the orthodontic plate to better suit particular applications. Additionally, the orthodontic plate 100 may be any of a number of shapes, including, but not limited to a “T,” “L,” “S,”, “Y,” “U,” “H,” “X,” “W,” “Z,” double “Y,” longitudinal, and double “T.” Additionally, the orthodontic plate 100 may initially have one shape, which the oral surgeon may change. For example, the oral surgeon may cut off a portion of the base 102 of a “T” shape to form an “L” shape, or the oral surgeon may rotate portions of the base 102 of a “T” shape to form a “Y” shape. Additionally, the length of the stem 104 may vary, depending on the specific treatment. A longer stem 104 may be appropriate for larger anatomy and greater extrusions of teeth, while a shorter stem 104 may be desirable for smaller anatomy and greater intrusion of teeth.

The shape and length of the orthodontic plate 100 depends upon the kind of tooth movement sought, e.g. distalization, extrusion, or intrusion, the number of teeth to be moved, the space available, and the location within the mouth at which the orthodontic plate 100 is to be attached. Moreover, the oral surgeon may trim portions of branches and/or remove entire branches from the orthodontic plate, in order to modify and/or reduce the profile to suit a particular application.

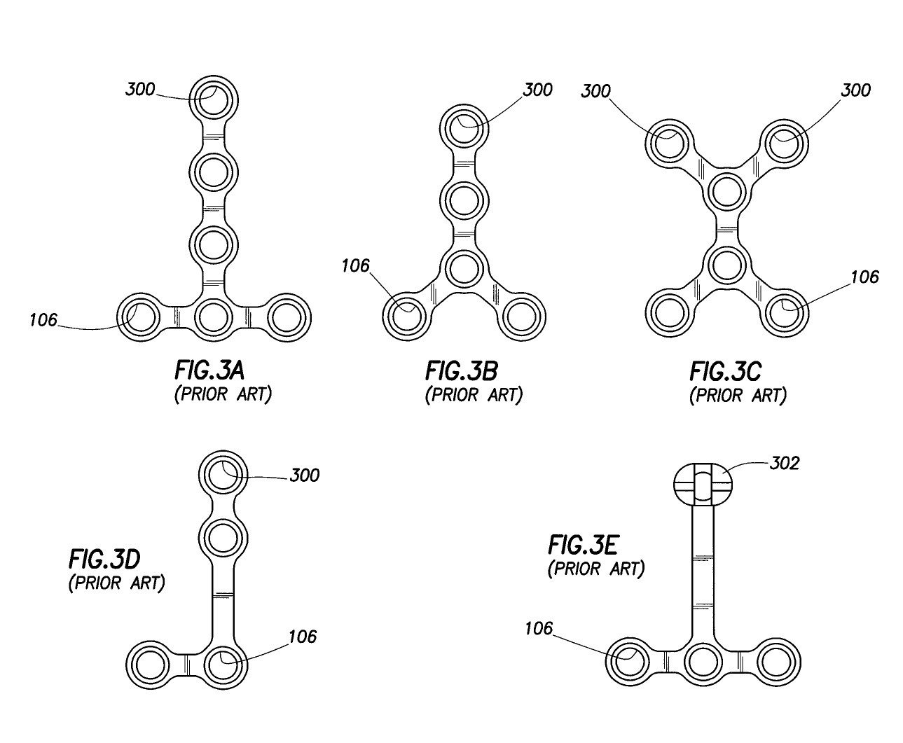

A variety of known orthodontic and miniature/mini-bone plates are shown in FIGS. 3A-3E. These plates are currently manufactured and readily obtainable from companies such as KLS Martin L. P. of Jacksonville, Fla., Walter Lorenz Surgical Instruments, Inc. of Jacksonville, Fla., and Stryker Corp. of Kalamazoo, Mich. FIGS. 3A through 3D show plates that are substantially planar. However, these plates do not have branches to which various closed orthodontic connectors may be connected. Instead, they have holes 300, through which only wire and other like connectors may be threaded. Using a chain, band, or other closed orthodontic connector would be difficult, if not impossible in the prior planar plates. FIG. 3E shows a prior plate having a wire guide 302 attached to the planar portion. While the plate of FIG. 3E allows for more configurations, the wire guide 302 necessarily protrudes out of the plane of the plate to accomplish this.

In view of the construction of the orthodontic plate 100 as shown in FIGS. 4 and 5, it will be understood by those skilled in the art that the orthodontic plate 100 of the present invention is secured against bone 402 in the selected location. As the oral surgeon places the orthodontic plate 100, he may bend the base 102 to conform to the shape of the surface of the bone 402. Additionally, the oral surgeon may bend the stem 104 in a direction and at the angle for optimal attachment to and movement of the tooth. The oral surgeon passes one or more fasteners 400 through the holes 106 in the base 102 to pull the base 102 down firmly against the bone 402. The oral surgeon then surgically closes the periosteum and other soft tissues in the customary manner, covering the base 102 and leaving the stem 104 protruding through the soft tissue. The branches 108 at the distal end of the stem 104 are exposed and ready to be connected using orthodontic wire, chains, bands, threads, or other orthodontic connectors to orthodontic brackets 404 on the teeth. The orthodontic plate 100 can be loaded immediately following placement, and the orthodontist can adjust the orthodontia as needed.

In FIG. 4, fasteners 400 fix a T-shaped orthodontic plate 100 to the bone 402. An elastic band 406 attaches the branches 108 of the orthodontic plate 100 to a prong 408 of bracket 404 of tooth 410 so that supereruption of the tooth 410 may occur.

In FIG. 5, fasteners 400 secure the orthodontic plate 100 to the bone 402 beneath the space created by a missing tooth. The stem 104 may bend out for proper fit. An elastic band 406 loops around any of the branches 108 and the brackets 404 on teeth 500 and 504 to move the tooth 500 so as to close the space between the teeth 500 and 504 and to achieve correct alignment. The bendability of the orthodontic plate 100 allows adaptability to the various bony configurations and directional needs in the mouth.

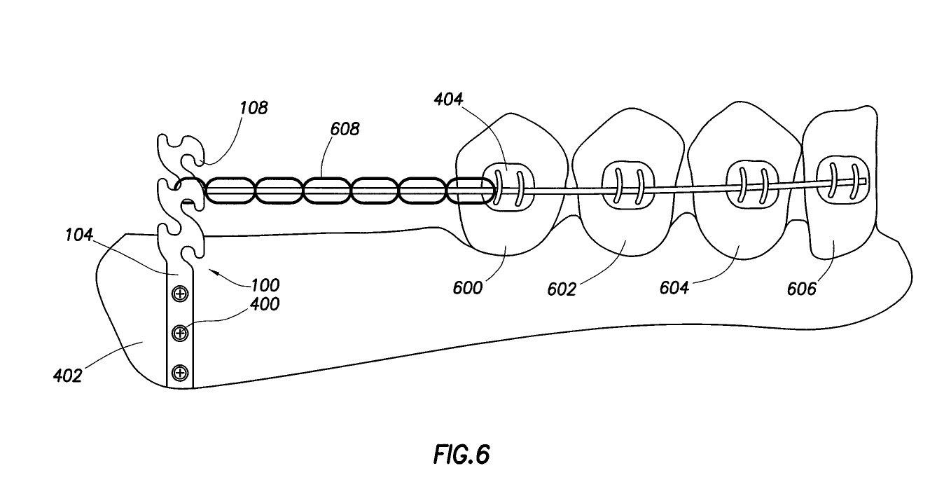

The present invention can also be used when few, if any anchoring teeth exist as shown in FIG. 6. A longitudinal orthodontic plate 100 attaches in the posterior portion of the bone 402 for anchorage. Chains 608 attach the branches 108 to bracket 404 on a nearest anterior tooth 600, which is attached with wire to brackets 404 on other abutting anterior teeth 602, 604, and 606. This allows for distalization of the anterior teeth 600, 602, 604, and 606.

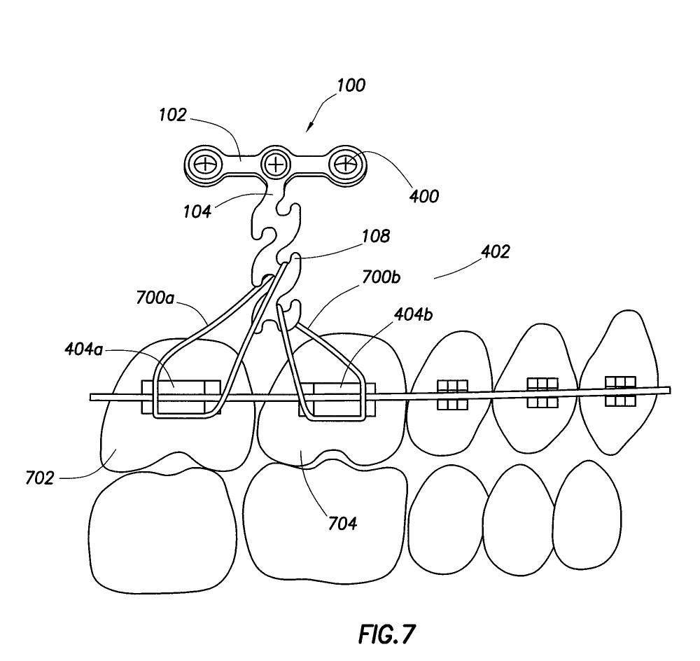

In FIG. 7, fasteners 400 secure the orthodontic plate 100 against the bone 402, leaving the stem 104 with branches 108 protruding through the soft tissues. Orthodontic wires 700a and 700b connect branches 108 and brackets 404a and 404b, respectively. This produces force in the superior direction for intrusion of teeth 702 and 704 to close an open bite deformity.

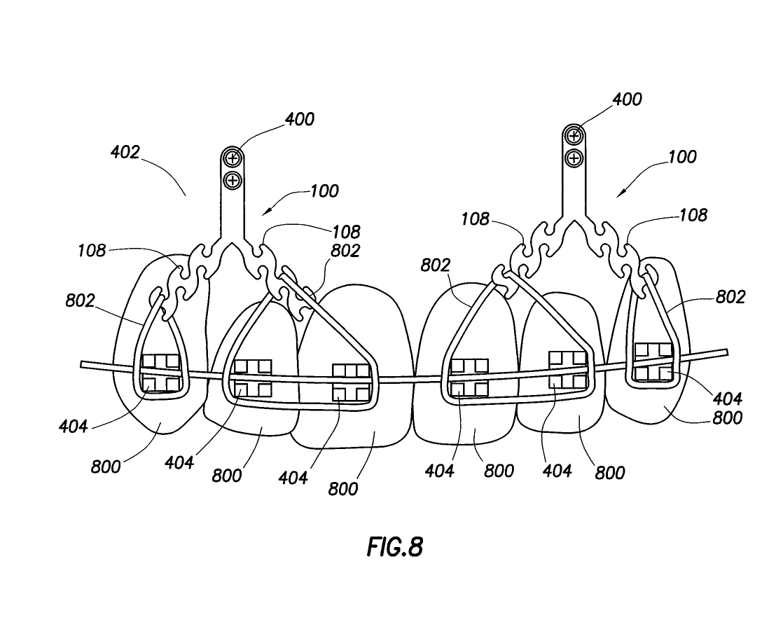

There are times when a tooth has extruded because of a lack of tooth contact from the opposing arch. In these instances, it is desirable to intrude the tooth back to its desired position. FIG. 8 shows two orthodontic plates 100 secured high up onto bone 402 using fasteners 400, creating upwardly directed force to intrude teeth 800. Orthodontic wires 802 connect brackets 404 to branches 108. The reverse configuration (not shown) to extrude teeth 800, for example, would require orthodontic plate 100 placement low on the mandibular bone with pronged brackets utilizing elastics connected from the branches 108 to the brackets 404 on the teeth 800 to be extruded. The same type of connection to extrude mandibular teeth could be used with the orthodontic plate 100 attached high on the maxillary bone or low on the mandibular bone.

The present invention's branches 108, integrally molded or separately affixed at the distal end of the stem 104, improve anterior and posterior movement of teeth while providing a number of points of anchorage, even when teeth are missing. The branches 108 also provide for a virtually unlimited number of directional configurations, allow for increased directional control, all while utilizing devices and techniques with which an orthodontist is familiar.

Thus, the present invention provides an orthodontic plate that may be temporarily fixated against the surface of the bone 402 and situated underneath soft tissues. The oral surgeon may bend the base 102 and the stem 104 at the time of surgery to conform to the bone 402 and the direction of alignment sought. The oral surgeon then fastens the base 102 down, pulling the orthodontic plate 100 into firm, conforming engagement against the bone 402. The stem 104, having branches 108 fixated at the distal end, protrudes through the soft tissues. The orthodontist may immediately attach wire, chains, springs, elastic bands, thread, or other orthodontic connectors to the orthodontic plate 100 and to any orthodontic appliance. One or more orthodontic plates 100 may be used to provide proper anchoring, directional force and control as needed in the judgment of the orthodontist.

The dimensions of the orthodontic plate 100 will vary, depending on the size and location of the orthodontic plate 100. The thickness should not create excessive bulk under the soft tissue. However, the orthodontic plate 100 should be thick enough to support the loads for which it is intended. Depending on the application, the thickness, length, and width may be adapted, along with the material. For example, the orthodontic plate 100 may be ASTM F67 Grade 2 Titanium that is 0.028″ thick, 0.89″ long, and 0.95″ wide, and capable of withstanding up to 600 grams of force in any direction within the plane formed by the base 102, the stem 104 and the branches 108. Alternatively, increasing the length of the stem 104, allows the orthodontic plate 100 to be longer. For example, the orthodontic plate 100 may be 0.96″ or 1.03″ long.

The structure of the orthodontic plate 100, including the branches 108 is desirably titanium or titanium alloy, however, stainless steel or any other moldable, durable biocompatible material can be used so long as it is capable of supporting sufficient shear forces to serve as an anchor. The branches 108 are desirably integrally molded at the distal end of the stem 104 of the orthodontic plate 100, however, other methods of attachment and permanent fixation generally accepted in the industry and usable orally may be employed. The surface of the orthodontic plate 100 is desirably smooth, particularly the stem 104. The branches 108 may span out beyond the edges of the stem 104, or the branches 108 may be no wider than the stem 104.

Although according to this invention, the branches 108 could be fixedly attached to a standard titanium or other biocompatible stem 104, via soldering, glue, or other permanent fixation method known within the art, after each is separately manufactured, it is believed that the shear strength of the completed apparatus would be less and cost of manufacture and potential for incompatibility may be higher than with unitary molding. This unitary molding may also allay possible concerns within the medical/dental community of biocompatibility, durability, structural integrity, and compliance with guidelines of the Food and Drug Administration in the United States. Lastly, in order to maintain the branches 108 in the same thin plane as the stem 104 and the base 102, it is highly desirable that the orthodontic plate 100 be constructed from a single sheet of material.

The orthodontic plate 100 is able to resist both horizontal forces and vertical forces and may be used with any conventional orthodontic appliance. This allows for molar intrusion or extrusion as well as lateral and medial movement.

The orthodontic plate 100 is installed in accordance with the following procedures. These are generalized for an understanding of the invention, and do not address all detailed procedures which would typically be followed by an orthodontist.

Under local anesthesia, the oral surgeon makes an incision such that he may place the orthodontic plate 100 at the desired location. The oral surgeon then places at least one orthodontic plate 100 directly against the bone 402 and secures it. One or more stems 104 having branches 108 at the distal end protrude through the gum. The oral surgeon closes the soft tissue incision using standard techniques. Placement of each orthodontic plate 100 generally takes about 10 minutes. Saline rinses, mild antiseptic mouthwashes and thorough brushing of teeth usually control any mild infections, however, some patients may require antibiotics and analgesics, based on the judgment of the oral surgeon. This surgical procedure causes minimal pain and swelling, and the incision generally completely heals in approximately 5-7 days. After the oral surgeon places the orthodontic plate 100, he can immediately attach the branches 108 to other orthodontic appliances using wires, chains, bands, springs, or other orthodontic connectors. The orthodontic plate 100 then acts as an anchor to hold the desired tooth in place or to move teeth or as a substitute anchoring point where teeth are missing. The orthodontic plate 100 will serve as a point of absolute anchorage, preventing movement of the anchored teeth. The remaining dentition will be treated with conventional orthodontic appliances where indicated.

At the conclusion of the orthodontic treatment utilizing the orthodontic plate 100, the oral surgeon removes the orthodontic plate 100. Under local anesthesia, he makes an incision, exposing the entire orthodontic plate 100. The oral surgeon then removes the fasteners 400, along with the orthodontic plate 100. Lastly, the oral surgeon closes the incision using conventional techniques and procedures. Saline rinses may be used to aid healing.

Those skilled in the art should understand that the directions used herein, such as top, bottom, up, and down are relative to the bone 402 on which the orthodontic plate 100 is being mounted. The term “tooth” is often used when the term “teeth” may also be applicable. This is not intended as a limitation, and wherever practicable, the term “tooth” is intended to mean “tooth or teeth.” The term “bracket” is used generically to mean any orthodontic appliance including, but not limited to, brackets, tubes, or hooks. The term “orthodontist” means any dental professional who may use this type of device, including an oral surgeon.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

1. An orthodontic plate, comprising:
a base;
a stem extending from the base;
a plurality of branches extending from the stem, the plurality of branches forming a first plurality of open ended recesses on a first side of the stem and a second plurality of open ended recesses on a second side of the stem, each open ended recess being connectable to at least one orthodontic bracket using an orthodontic connector; and
wherein the base, the stem and the plurality of branches are formed from an integral, unitary body.

2. (canceled)

3. The orthodontic plate of claim 1, wherein each of the branches are configured to form a respective open ended recess of the first or the second plurality of open ended recesses.

4. (canceled)

5. The orthodontic plate of claim 1, wherein the plurality of branches are configured such that the orthodontic plate can be used for both intrusion and extrusion of teeth.

6. The orthodontic plate of claim 1, wherein the base, the stem, and the plurality of branches all lie substantially within a single plane.

7. The orthodontic plate of claim 6, wherein the plurality of branches are configured such that the orthodontic plate can support a load in any direction lying substantially within the single plane.

8. (canceled)

9. The orthodontic plate of claim 1, wherein the first plurality of open ended recesses each face a first direction, and the second plurality of open ended recesses each face a second direction, the first direction being approximately opposite to the second direction.

10. The orthodontic plate of claim 1, wherein at least one of the first plurality of open ended recesses is configured to receive a first orthodontic connector to support a first load in a first range of directions, and at least one of the second plurality of open ended recesses is configured to receive a second orthodontic connector to support a second load in a second range of directions, wherein the first range of directions is different than the second range of directions.

11. The orthodontic plate of claim 10, wherein the first range of directions and the second range of directions are each within the range of 220 to 280 degrees, and the first range of directions overlaps with the second range of directions by no more than approximately 60 to 80 degrees.

12. The orthodontic plate of claim 6, wherein the branches are rigid enough to withstand typical orthodontic loads, and flexible enough to allow one or more of the plurality of branches to be bent out of the single plane until the one of the plurality of branches is perpendicular to the single plane.

13. An orthodontic plate for use as a temporary bone anchor in conjunction with orthodontic treatment, the orthodontic plate comprising:
a single sheet of material comprising:
a base which is connectable to bone;
a stem coupled to the base; and
a plurality of branches coupled to the stem, the plurality of branches forming a first plurality of open ended recesses on a first side of the stem, and a second plurality of open ended recesses on a second side of the stem; and
wherein each branch of the plurality of branches is configured to be coupled to at least one orthodontic bracket using an orthodontic connector.

14. The orthodontic plate of claim 13, wherein the single sheet of material is selected from the group consisting of titanium, stainless steel and bioresorbable polymers.

15. The orthodontic plate of claim 13, wherein the base may be bent to conform with a bone.

16. The orthodontic plate of claim 17, wherein one or more of the plurality of branches may be bent away from the single plane.

17. The orthodontic plate of claim 13, wherein the single sheet of material lies substantially within a single plane.

18. The orthodontic plate of claim 17, wherein the plurality of branches is configured such that the orthodontic plate can support a load in any direction lying substantially within the plane.

19. An orthodontic plate for use as a temporary bone anchor in conjunction with orthodontic treatment, the orthodontic plate comprising:
a single sheet of material comprising:
a base which is connectable to bone, wherein the base lies substantially within a plane;
a stem extending from the base, wherein the stem lies substantially within the plane; and
a plurality of branches extending from the stem, wherein the plurality of branches lies substantially within the plane;
wherein any branch of the plurality of branches is connectable to at least one orthodontic bracket via a closed orthodontic connector;
wherein the plurality of branches is configured such that the orthodontic plate can support a load in any direction lying substantially within the plane; and
wherein the plurality of branches form a first plurality of open ended recesses on a first side of the stem and a second plurality of open ended recesses on a second side of the stem.

20. A method for forming an orthodontic plate, comprising:
providing a sheet of material and forming from the sheet of material:
a base having a plurality of holes formed therein;
a stem extending from the base;
a plurality of branches extending from the stem and
a first plurality of open ended recesses on a first side of the stem and a second plurality of open ended recesses on a second side of the stem, each of the open ended recesses being connectable to at least one orthodontic bracket using an orthodontic connector.

21. The method of claim 20, wherein each of the branches is configured to form a respective open ended recess of the first or the second plurality of open ended recesses.

22. The method of claim 20; wherein the sheet of material comprises a material selected from the group consisting of titanium, stainless steel and bioresorbable polymers.
